(19) United States
(12) Patent Application Publication
(10) Pub. No.: US 2016/0219583 A1
(43) Pub. Date: Jul. 28, 2016

(54) SUB FRAME TIMING FOR HARQ LTE HD-FDD

(71) Applicant: Telefonaktiebolaget L M Ericsson (publ), Stockholm (SE)

(72) Inventor: Yufei BLANKENSHIP, Kildeer, IL (US)

(21) Appl. No.: 14/649,180

(22) PCT Filed: Apr. 24, 2015
(86) PCT No.: PCT/SE2015/050461

§ 371 Date: Jun. 2, 2015

Related U.S. Application Data
(60) Provisional application No. 61/990,779, filed on May 9, 2014.

(51) Int. Cl. H04W 72/04; H04W 72/12; H04L 5/16; H04W 74/04

(52) U.S. Cl. CPC H04W 72/0446; H04W 74/04; H04W 72/1284; H04W 72/1289; H04L 5/16

(57) ABSTRACT

The disclosure relates to low-cost UE operation in Half Duplex Frequency Division Duplex, HD-FDD, mode. In particular it relates to a method of configuring subframe timing for LTE HD-FDD. According to some aspects the disclosure relates to a method, performed in a first radio network node 10 in a cellular communication network, of communicating with a second radio network node using HD-FDD. The method comprises sharing S2 a pre-defined subframe configuration pattern with the second radio network node, and switching S4 between transmission and reception in accordance with the shared subframe configuration pattern, when exchanging data between the first radio network node and the second radio network node. The disclosure also relates to a corresponding network node and computer program.

### TECHNICAL FIELD

The disclosure relates to low-cost User Equipment, UE, operation in Half-Duplex Frequency Division Duplex, HD-FDD, mode. In particular it relates to a method of configuring subframe timing for HD-FDD and to a corresponding network node and computer program.

### BACKGROUND

3GPP Long Term Evolution, LTE, is the fourth-generation mobile communication technologies standard developed within the 3rd Generation Partnership Project, 3GPP, to improve the Universal Mobile Telecommunication System, UMTS, standard to cope with future requirements in terms of improved services such as higher data rates, improved efficiency, and lowered costs. The Universal Terrestrial Radio Access Network, UTRAN, is the radio access network of a UMTS and Evolved UTRAN, E-UTRAN, is the radio access network of an LTE system. In an UTRAN and an E-UTRAN, a User Equipment, UE, is wirelessly connected to a Radio Base Station, RBS, commonly referred to as a NodeB, NB, in UMTS, and as an evolved NodeB, eNodeB or eNB, in LTE. An RBS is a general term for a radio network node capable of transmitting radio signals to a UE and receiving signals transmitted by a UE.

Transmission and reception from a node, e.g. a user equipment in a cellular system such as Long Term Evolution, LTE, can be multiplexed in the frequency domain or in the time domain (or combinations thereof). Frequency Division Duplex, FDD, as illustrated to the left in FIG. 1 implies that downlink and uplink transmission take place in different, sufficiently separated, frequency bands. Time Division Duplex, TDD, as illustrated to the right in FIG. 1, implies that downlink and uplink transmission take place in different, non-overlapping time slots. Thus, TDD can operate in unpaired spectrum, whereas FDD requires paired spectrum.

Typically, the structure of the transmitted signal in a communication system is organized in the form of a frame structure. For example, LTE uses ten equally-sized subframes of length 1 ms per radio frame as illustrated in FIG. 2.

In case of FDD operation (upper part of FIG. 2), there are two carrier frequencies, one for uplink transmission, f_{UL}, and one for downlink transmission, f_{DL}. At least with respect to the terminal in a cellular communication system, FDD can be either full duplex or half duplex. In the full duplex case, a terminal can transmit and receive simultaneously, while in half-duplex operation, the terminal cannot transmit and receive simultaneously (the base station is capable of simultaneous reception/transmission though, e.g. receiving from one terminal while simultaneously transmitting to another terminal). In LTE, a half-duplex terminal is monitoring/receiving in the downlink except when explicitly being instructed to transmit in a certain subframe.

In case of TDD operation (lower part of FIG. 2), there is only a single carrier frequency and uplink and downlink transmissions are always separated in time also on a cell basis. As the same carrier frequency is used for uplink and downlink transmission, both the base station and the mobile terminals need to switch from transmission to reception and vice versa. An aspect of any TDD system is to provide the possibility for a sufficiently large guard time where neither downlink nor do uplink transmissions occur. This is required to avoid interference between uplink and downlink transmissions. For LTE, this guard time is provided by special subframes (subframe 1 and, in some cases, subframe 6), which are split into three parts: a downlink part, DwPTS, a guard period, GP, and an uplink part, UpPTS. The remaining subframes are either allocated to uplink or downlink transmission.

TDD allows for different asymmetries in terms of the amount of resources allocated for uplink and downlink transmission, respectively, by means of different downlink/uplink configurations. In LTE, there are seven different configurations as shown in FIG. 3. Note that in the description below, DL subframe can mean either DL or the special subframe.

To avoid severe interference between downlink and uplink transmissions between different cells, neighbor cells should have the same downlink/uplink configuration. If this is not done, uplink transmission in one cell may interfere with downlink transmission in the neighboring cell (and vice versa) as illustrated in FIG. 4. Hence, the downlink/uplink asymmetry can typically not vary between cells, but is signaled as part of the system information and remains fixed for a long period of time.

An important aspect of the communication industry today is the development of Internet of Things. That is, to connect devices, systems and services that goes beyond the traditional machine to machine, M2M. For example, a device like a light post is equipped with communication means so that it can be controlled remotely and so that it can communicate light failure. For it to be possible to equip such devices with communication means and still keep it at a reasonable cost, low cost User Equipments, UEs, are used. However, it has been pointed out that an important issue for low-cost UE operation is half-duplex FDD, HD-FDD, mode. Low cost UEs are as simple communication devices as possible and does therefore only have one oscillator which requires longer time when switching between uplink and downlink in HD FDD.

In Rel-8 HD-FDD, certain sub-frames are assigned for uplink or downlink transmission dynamically as a result of the scheduler operation. However, there may be conflicts between downlink reception, uplink transmission, and guard period that are not completely avoidable by scheduling.

This problem is exacerbated if the low-cost UE requires longer time to switch from Uplink, UL, to Downlink, DL, and switch from DL to UL. It has been observed that

(a) For low complexity HD-FDD Machine Type Communication, MTC, UE, the Rx-to-Tx switching time is up to 1 ms if single oscillator is used;

(b) For low complexity HD-FDD MTC UE, the Tx-to-Rx switching time is up to 1 ms if single oscillator is used;

With Rx-to-Tx switching and Tx-to-Rx switching each is allowed to take the duration of up to one subframe, it is inadequate to rely on scheduler operation for HD-FDD operation, because there is a risk that the UE will not be able to receive or transmit when scheduled to do so, due to the switching time as well as the potential conflict between the DL reception and UL transmission.

Considering the downlink and uplink signals discussed above, it is clear that conflict between uplink and downlink can often happen in HD-FDD mode. Hence, there is a need for improved methods of communicating with a second radio network node using Half Duplex Frequency Division Duplex, HD-FDD.

### SUMMARY

The general object or idea of embodiments of the present disclosure is to address at least one or some of the disadvantages with the prior art solutions described above as well as below.

According to some aspects, the disclosure relates to a method, performed in a first radio network node in a cellular communication network, of communicating with a second radio network node using Half Duplex Frequency Division Duplex, HD-FDD. The method comprises sharing a pre-defined subframe configuration pattern with the second radio network node, and switching between transmission and reception in accordance with the shared subframe configuration pattern, when exchanging data between the first radio network node and the second radio network node.

At least one example advantage of the above is that by defining a UE-specific subframe pattern the periodic DL channel/signal is guaranteed to be received when they coincide with the configured DL subframe, and the periodic UL channel/signal are guaranteed to be received when they coincide with the configured UL subframe. When the periodic DL channel/signal falls outside of the designated DL subframes (i.e., fall under subframes for uplink or guard), then those DL channel/signals are skipped by the UE. When the periodic UL channel/signal falls outside of the designated UL subframes (i.e., fall under subframes for downlink or guard), then those UL channel/signals are dropped by the UE.

The methods allow the UE and eNB to achieve correct mutual understanding of timing of DL subframe, UL subframe, and guard period. Thus half-duplex FDD can operate properly with expected behavior from eNB and UE.

According to some aspects, the subframe configuration pattern specifies the subframes used for Uplink and Downlink during a period of time.

According to some aspects, the period of time is a multiple of a periodic pattern. Hence, each time period will comprise a multiple of a periodic pattern. The period of the pattern is e.g. 40 LTE sub frames, due to the HARQ round trip time. According to some aspects, the subframe configuration pattern implies that downlink transmissions are scheduled at the 0th, 1st, 2nd, 8th, 9th, 10th, 16th, 17th, 18th, 24th, 25th, 26th, 32nd, 33rd, 34th sub frames every 40th sub frame, which corresponds to a pattern suitable for 3 HARQ processes.

According to some aspects, the subframe configuration pattern is selected from a number of predefined configurations. The disclosure provides several methods to define subframe pattern configuration for HD-FDD. Multiple patterns are described, and the eNB/UE can choose from an appropriate pattern from the multiple options to use on the link between eNB and UE. The pattern selection can take several factors into account, including UE capability (or UE hardware implementation), timing advance (or propagation time between eNB and UE), UL buffer status, DL buffer status, etc. The selected pattern can be updated between eNB and UE when necessary, in a semi-static manner. The pattern selection and pattern update can be initiated by the eNB or the UE.

According to some aspects, the method further comprises obtaining a timing advance between the first and the second radio network node, obtaining a radio access capability of one of the radio network nodes being a wireless device; and selecting the subframe configuration pattern based on the obtained timing advance and radio access capability.

According to some aspects, the sharing comprises sending an indicator of the subframe configuration pattern to the second radio network node.

According to some aspects, the sharing comprises receiving an indicator of the subframe configuration.

According to some aspects, the method further comprises calculating a UE-specific parameter of the subframe configuration pattern.

According to some aspects, the UE-specific parameter is a starting point of the subframe configuration pattern.

According to some aspects, the method further comprises the step of detecting an event triggering the sharing of a subframe configuration pattern.

According to some aspects the disclosure relates to a corresponding computer program configured to cause a network node to perform the methods described above and below.

According to some aspects, the disclosure relates to a first radio network node in a cellular communication network configured to share a pre-defined subframe configuration pattern with the second radio network node, and to switch between transmission and reception in accordance with the shared subframe configuration pattern, when exchanging data between the first radio network node and the second radio network node.

According to some aspects, the subframe configuration pattern specifies the subframes used for Uplink and Downlink during a period of time. According to some aspects, the subframe configuration pattern specifies subframe(s) that are wholly or partially used as guard period.

According to some aspects, the period of time is a multiple of a periodic pattern. The periodicity of the pattern is e.g. 40 LTE sub frames. According to some aspects, the subframe configuration pattern implies that downlink transmissions are scheduled at the 0th, 1st, 2nd, 8th, 9th, 10th, 16th, 17th, 18th, 24th, 25th, 26th, 32nd, 33rd, 34th sub frames every 40th sub frame.

### BRIEF DESCRIPTION OF THE DRAWINGS

Further objects, features, and advantages of the present disclosure will appear from the following detailed description, wherein some aspects of the disclosure will be described in more detail with reference to the accompanying drawings, in which:

FIG. 1 shows an explanation of frequency- and time-division duplex.

FIG. 2 shows uplink/downlink time/frequency structure for LTE in case of FDD and TDD.

FIG. 3 shows different downlink/uplink configurations in case of TDD.

FIG. 4 shows UL-DL interference in TDD.

FIG. 5 is a flow chart illustrating the proposed method performed in a first radio network node according to some aspects of the disclosure.

FIG. 6 is a schematic diagram illustrating a first radio network node according to some aspects of the disclosure.

FIG. 7 depicts an exemplifying radio communications system 100 in which embodiments herein may be implemented.

FIG. 8 shows the HD-FDD assumption according to prior art.

FIG. 9 shows a scenario with short radio switch time, large TA such that one whole DL subframe may not be used for reception.

FIG. 10 shows a scenario with long radio switch time, large TA such that two whole DL subframe may not be used for reception.

FIG. 11 illustrates that maximum number of HARQ processes possible is 4 for HD-FDD operation.

FIG. 12 illustrates that the maximum number of HARQ processes possible is 3 for low-cost UE when TA≦0.5 ms.

FIG. 13 illustrates that the maximum number of HARQ processes possible is 2 for low-cost UE when TA>0.5 ms.

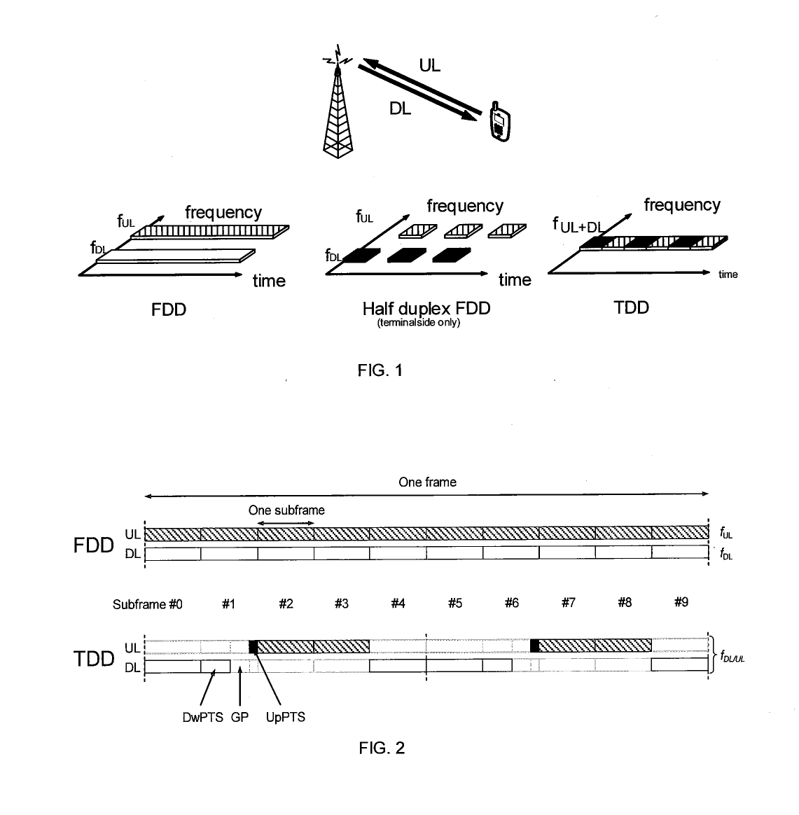

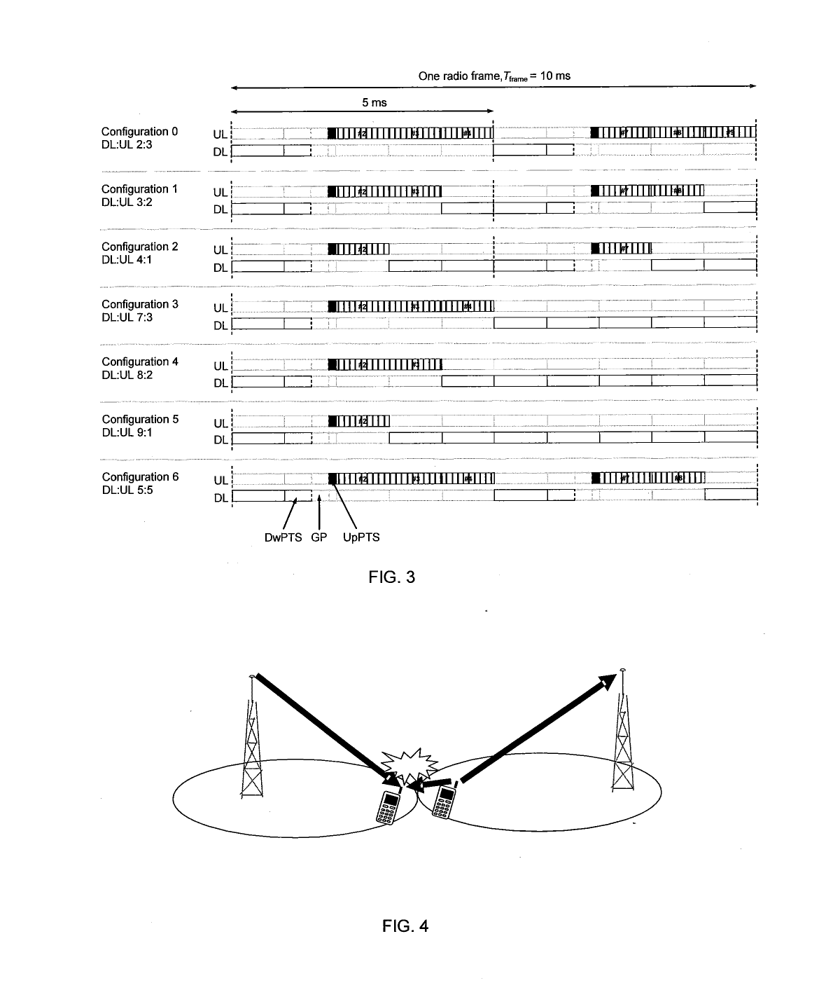

### DETAILED DESCRIPTION

Aspects of the present disclosure will be described more fully hereinafter with reference to the accompanying drawings. The device and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

According to some aspects, this disclosure discusses how to define the HD-FDD UE behavior when facing timing conflicts between the variety of downlink and uplink signals, in the presence of guard subframes.

As mentioned above, in Rel-8 HD-FDD, certain sub-frames are assigned for uplink or downlink transmission dynamically as a result of the scheduler operation. However, there are conflicts between downlink reception, uplink transmission, and guard period that are not completely avoidable by scheduling as discussed above.

As an introduction some mandatory downlink and uplink channels of LTE are briefly presented.

Downlink Signals

On the downlink, normally there are several subframes that an FDD UE is required to receive. These channels are now briefly described.
a) Paging.
For a UE in Radio Resource Control_IDLE, RRC_IDLE, mode, the UE needs to be prepared to receive the paging channel in subframe #0, #4, #5, and #9. Paging is also used in RRC_CONNECTED to notify a coming modification of SIBs.
b) Physical Broadcast Channel, PBCH/System Information Block 1, SIB1/Primary Synchronization Signal, PSS/Secondary Synchronization Signal, SSS.
For UE in RRC_CONNECTED mode, the UE needs to always receive subframes #0 and #5, which carry broadcast type of information including PBCH, SIB1, PSS, and SSS. Due to the implementation, low-cost UE likely needs to receive multiple instances of PBCH/SIB1/PSS/SSS to properly receive it.
c) Physical Hybrid automatic repeat request Indicator Channel, PHICH.

When the eNB is expected to transmit PHICH in response to an earlier Physical Uplink Shared Channel, PUSCH, transmission, normally the UE needs to switch to DL to receive the PHICH. Compared to paging and broadcast information, dropping of PHICH is tolerable since this can be made up by retransmission opportunities. It is worth noting that for the purpose of receiving PHICH, it is feasible that the UE only receives the control region (up to 4 OFDM symbols) while skipping the data region of the same subframe.
d) Channel State Information Reference Signals, CSI-RS.

The CSI-RS periodicity can be {5, 10, 20, 40, 80} subframes. The eNB can configure the CSI-RS such that the subframe for CSI-RS coincide with other required DL signals, for example, subframe #0 and #5. With this, CSI-RS does not impose additional constraint on the DL-UL subframe timing.
e) Semi-Persistent Scheduling, SPS, DL.

After a Semi-Persistent downlink assignment is configured, the UE shall consider sequentially that the DL assignment occurs with interval of semiPersistSchedIntervalDL, where semiPersistSchedIntervalDL is configured by RRC signaling. semiPersistSchedIntervalDL can be {10, 20, 32, 40, 64, 80, 128, 160, 320, 640} subframes. Similar to CSI-RS, SPS DL can be configured such that it does not impose additional constraint on the DL-UL subframe timing.

For low-cost UE operating in HD-FDD mode, it is still necessary to receive the mandatory DL information listed above. Whenever possible, the UE needs to finish ON-to-OFF switching (when necessary), and be ready to receive the above-mentioned subframes on the downlink. If there is a conflict between DL reception and a lower-priority uplink transmission in these subframes, the DL signal can be protected by skipping the UL transmission.

Uplink Signals

On the uplink, while the initial transmission of a PUSCH is controllable by UL grants, there are several other types of channel/signal that a HD-FDD UE needs to transmit.
(a) Physical Random Access Channel, PRACH.

The UE needs to be able to perform random access by transmitting PRACH. The random access procedure can be triggered for a variety of reasons, such as UL data arrival and timing advance adjustment. PRACH should be assigned high priority since loss of PRACH opportunity may mean loss of physical connection.
(b) Scheduling Request, SR.

SR may be carried by Physical Uplink Control Channel, PUCCH, with a periodicity of {1, 2, 5, 10, 20, 40, 80} ms. Due to the need to receive mandatory DL channels, it is impractical for a low-cost HD-FDD UE to accommodate the low end of the SR periodicity. It is desirable to maintain only the larger SR periodicity, for example, {5, 10, 20, 40, 80} ms.
(c) Periodic Channel State Information, CSI, reporting using PUCCH.

Periodicity for FDD may be {2, 5, 10, 20, 40, 80, 160, 32, 64, 128} ms. Similar to SR, it is impractical to have low periodicity of CSI reporting in HD-FDD mode. Considering the UL Hybrid Automatic Repeat Request, HARQ, round trip time of 8 ms, it is desirable to maintain only the larger CSI periodicity of {40, 80, 160, 64, 128} ms.
(d) HARQ Acknowledge, HARQ-ACK, in response to DL transmission.

There is a predefined {n, n+4} relationship between a Physical Downlink Shared Channel, PDSCH, and its HARQ-ACK on the uplink. For HD-FDD under timing conflict, although it is undesirable, dropping of HARQ-ACK is not crippling since it can be simply treated as DTX which can already happen due to missed uplink grant or fading channel. The eNB will by default compensate by retransmission of the same transport block.
(e) PUSCH retransmission.

For uplink data, the HARQ process synchronous, such that a retransmission follows 8 subframes after the initial transmission if the initial transmission failed. For HD-FDD under timing conflict, although undesirable, dropping of a PUSCH retransmission is acceptable since this can be treated the same as loss of PUSCH due to fading channel. The eNB will send a negative-acknowledge, NACK, on PHICH (or Physical Downlink Control Channel, PDCCH), requesting a retransmission from the UE.
(f) Sounding reference signal, SRS.

For Type 0 SRS configuration, the UE-specific SRS periodicity for FDD can be {2, 5, 10, 20, 40, 80, 160, 320}. For Type 1 triggered SRS configuration, the UE Specific SRS periodicity can be {2, 5, 10}.
(g) Semi-Persistent Scheduling, SPS, UL.

After a Semi-Persistent Scheduling uplink grant is configured, the UE shall consider sequentially that the UL grant occurs with interval of semiPersistSchedIntervalUL, where semiPersistSchedIntervalUL is configured by RRC signaling. semiPersistSchedIntervalUL can be {10, 20, 32, 40, 64, 80, 128, 160, 320, 640} subframes. Consider the HARQ round trip time of 8 subframes, it is preferred that the lower values of semiPersistSchedIntervalUL are not used in HD-FDD. That is, semiPersistSchedIntervalUL can be {32, 40, 64, 80, 128, 160, 320, 640} subframes for HD-FDD mode.

As stated above, there is a conflict between uplink and downlink can often happen in HD-FDD mode. This cannot be fully resolved by scheduler implementation alone. This disclosure therefore proposes introducing mechanisms defined such that both eNB and UE know what to expect when operating in HD-FDD mode.

This disclosure discusses the conflict resolution between downlink and uplink signals for HD-FDD UEs.

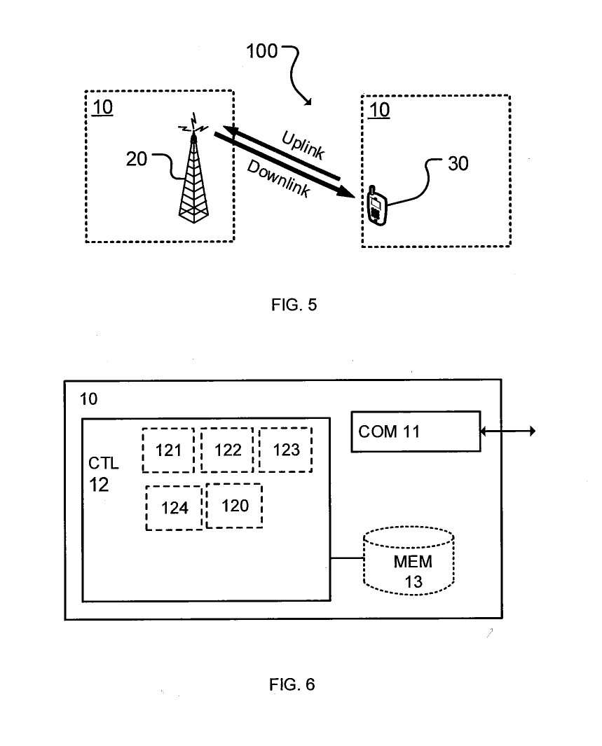

FIG. 5 depicts an exemplifying radio communications system 100 in which embodiments herein may be implemented. The radio communication system 100 comprises radio network nodes 10. As used herein, the term “radio network node” may refer to an access point 20 or a wireless device 30. The access point 20 and the wireless device 30 are communicating using HD-FDD.

In this example, the radio communications system 100 is a Long Term Evolution, LTE, system. In other examples, the radio communication system may be any Third Generation Partnership Project, 3GPP, cellular communication system, such as a Wideband Code Division Multiple Access, WCDMA, network, a Global System for Mobile communication, GSM, network, an evolution of any one of the above mentioned systems or the like.

This disclosure proposes e.g. that mechanisms are explicitly defined to resolve the timing conflict uplink/downlink/guard subframes and that periodicity ranges of periodic downlink and uplink channel/signals are revisited for HD-FDD and that only periodicities that are useful for HD-FDD operation are kept.

In prior art in the LTE specification, the half-duplex FDD mode does not have any predefined subframe timing pattern that defines subframe indices for downlink subframe, uplink subframe, and guard period. There is also no information exchange between eNB and UE about subframe pattern.

This disclosure proposes to define semi-static subframe pattern. Alternatively, if prioritization levels are not defined, the conflict can be resolved by defining a UE-specific subframe pattern, similar to the TDD subframe configuration. In this case, the timing of Uplink-Downlink-Guard subframe is known to both eNB and UE.

By defining a UE-specific subframe pattern the periodic DL channel/signal is guaranteed to be received when they coincide with the DL subframe, and the periodic UL channel/signal are guaranteed to be received when they coincide with the UL subframe. When the periodic DL channel/signal falls outside of the designated DL subframes (i.e., fall under subframes for uplink or guard), then those DL channel/signals are skipped by the UE. When the periodic UL channel/signal falls outside of the designated UL subframes (i.e., fall under subframes for downlink or guard), then those UL channel/signals are dropped by the UE.

The disclosure provides several methods to define subframe pattern configuration for HD-FDD. Multiple patterns are described, and the eNB/UE can choose an appropriate pattern from the multiple options to use on the link between eNB and UE. The pattern selection can take several factors into account, including UE capability (or UE hardware implementation), timing advance (or propagation time between eNB and UE), UL buffer status, DL buffer status, etc. The selected pattern can be updated between eNB and UE when necessary, in a semi-static manner. The pattern selection and pattern update can be initiated by the eNB or the UE.

The methods allow the UE and eNB to achieve correct mutual understanding of timing of DL subframe, UL subframe, and guard period. Thus half-duplex FDD can operate properly with expected behavior from eNB and UE.

Turning now to FIG. 6, a schematic diagram illustrating some modules of an example embodiment of a first radio network node 10 configured of the proposed method of communicating with a second radio network node using Half Duplex Frequency Division Duplex, HD-FDD, will be described. In this application the term radio network node 10 is any network node in the wireless network. The radio network node is according to aspects a user equipment, UE, such as a Machine Type device. The radio network node is according to another variant an access point such as an RBS or an eNodeB. Hence, the proposed method may be implemented either in the base station 10 or in the UE 20.

The first radio network node 10 comprises a controller, CTL, or a processing circuitry 12 that may be constituted by any suitable Central Processing Unit, CPU, microcontroller, Digital Signal Processor, DSP, etc. capable of executing computer program code. The computer program may be stored in a memory, MEM 13. The memory 13 can be any combination of a Read And write Memory, RAM, and a Read Only Memory, ROM. The memory 13 may also comprise persistent storage, which, for example, can be any single one or combination of magnetic memory, optical memory, or solid state memory or even remotely mounted memory.

The first radio network node 10 further comprises a radio communication interface (i/f), 11. The wireless communication interface 11 is arranged for wireless communication with other network nodes within range of the first radio network node 10. The radio communication interface 11 may be adapted to communicate over one or several radio access technologies. If several technologies are supported, the node typically comprises several communication interfaces, e.g. one WLAN or Bluetooth communication interface and one cellular communication interface.

According to some aspects, the radio network node 10 comprises a detector 120, a selector 121, a sharing module 122, a calculator 123 and a switcher 124 implemented in hardware or in software or in a combination thereof. The functionality of the modules will be described below. The modules 120, 121, 122, 123, 124 are according to some aspects implemented as a computer program stored in a memory 13 which run on the processing circuitry 12. The first radio network node 10 is further configured to implement all the aspects of the disclosure as described in relation to the methods above. The processing circuitry also comprises the corresponding modules.

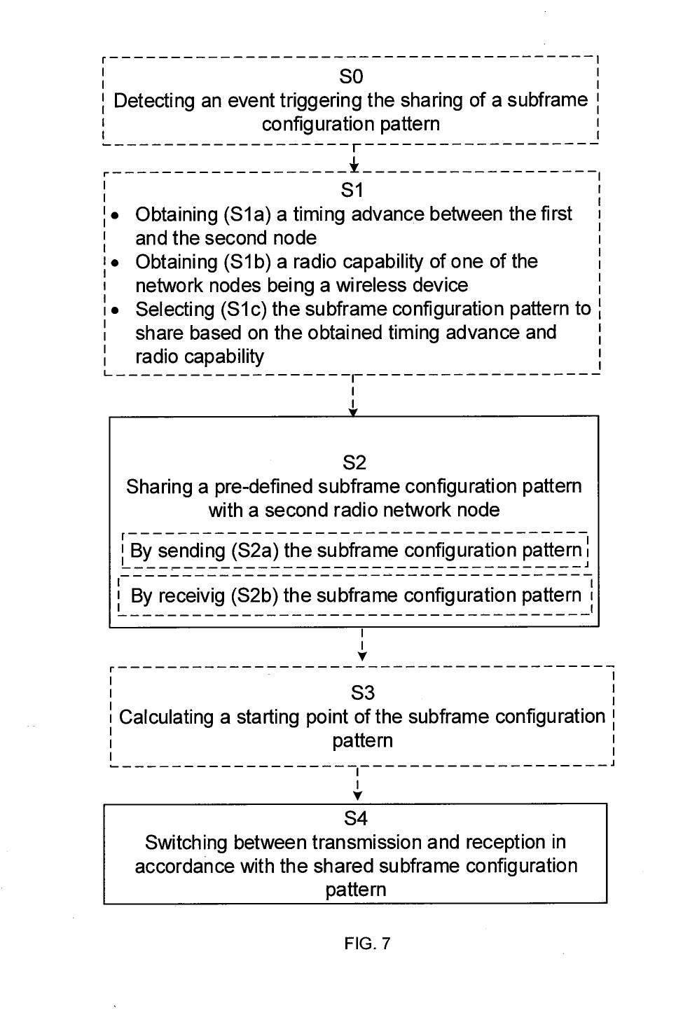

FIG. 7 is a flowchart illustrating the method steps, performed in a first radio network node 10, of the proposed method of communicating with a second radio network node, e.g. radio network node 20 or 30, using Half Duplex Frequency Division Duplex, HD-FDD.

The method, performed by a first radio network node 10, 20 in a cellular communication network of FIG. 6, of communicating with a second radio network node using Half Duplex Frequency Division Duplex, HD-FDD, will now be described referring to FIG. 7.

It should be appreciated that FIG. 7 comprises some operations and modules which are illustrated with a solid border and some operations which are illustrated with a dashed border. The operations and modules which are illustrated with solid border are operations which are comprised in a more general example embodiment. The operations and modules which are illustrated with dashed border are example embodiments which may be comprised in, or a part of, or are further embodiments which may be taken in addition to the operations and modules of the general example embodiments. It should be appreciated that the operations need not be performed in order.

The example below is performed in a LTE network. Therefore the wireless device is referred to as a UE and the access point is referred to as a eNodeB. However, this should be considered as an example only and the technique is applicable in other systems as well. The method may in principle be performed any time during a connection between two devices.

The method is according to a first embodiment performed in the first radio network node 10 being the access point 20. The first node communicates with a second radio network node, which is then a wireless device 30.

The method is according to a second embodiment performed in the first radio network node 10 being the wireless device 30. The first node communicates with a second radio network node, which is then an access point 20.

The basic idea is that there is a common pattern known to both the access point and the wireless device. However, in LTE the access point is generally responsible for scheduling the transmissions in both Downlink, DL, and Uplink, UL. Therefore the way the pattern is used is different in the access point and in the wireless device. However, the basic concept of sharing the subframe configuration pattern and transmitting and receiving in accordance with the pattern is similar in both sides. The embodiments will be further described below.

The method is typically initially performed at connection set-up e.g. in connection with the RACH procedure. However, the method may then be updated any time, because as will be shown it only affects the two involved devices. Hence, according to some aspects, the method comprises an initial step, S0, of detecting an event triggering the sharing of a subframe configuration pattern. The processing circuitry 12 is configured to perform this step. According to some aspects, the processing circuitry comprises a detector 120 adapted to perform this step. Hence, configuration may be triggered at connection setup, periodically and/or at certain events.

In a first step, the first radio network node 10 shares S2 a pre-defined subframe configuration pattern with the second radio network node. By sharing the subframe configuration pattern, the pattern is known by both the wireless device and the access point. Stated differently, the UE and the eNodeB obtains a pre-defined subframe configuration pattern, which is known to both the UE and the eNodeB. The pattern is typically UE specific, i.e. specific for each wireless device.

The processing circuitry 12 is configured to perform this step. According to some aspects, the processing circuitry comprises a sharing module 122 adapted to perform this step.

According to some aspects, the sharing implies that the pre-defined subframe configuration pattern is pre-programmed or pre-stored in the access point or wireless device respectively.

This may be done at manufacturing or when the radio network node is installed or configured. For example the pattern is standardized. According to some aspects, the sharing, S2, comprises sending, S2a, an indicator of the subframe configuration pattern to the second radio network node. According to some aspects, the step of sharing, S2, implies receiving, S2b, an indicator of the subframe configuration pattern from the second radio network node.

The subframe configuration pattern is shared by the wireless device and the access point. The subframe configuration pattern is e.g. selected in the first radio network node or in the second radio network node. The radio network node that selects the subframe configuration pattern informs the other network node about the subframe configuration pattern to use. Hence, if the radio network node is a UE, the UE may receive a determined subframe configuration pattern from the eNB and vice versa. If there are several standardized patterns, then the receiving or sending may involve sharing an indicator or identifier of a predefined configuration pattern.

According to some aspects, the subframe configuration pattern specifies the subframes used for Uplink, UL, and Downlink, DL, during a period of time. According to some aspects, the subframe configuration pattern further specifies subframe(s) that are wholly or partially used as guard period. A guard period is a time interval that is a portion of a burst period where no radio transmission can occur.

According to some aspects, the period of time or cycle comprises one or more periodic patterns. The subframe configuration pattern specifies e.g. subframes, or fractions thereof, used for UL, DL and guard periods during a defined period of time e.g. 40 LTE subframes. The subframe configuration pattern cycle is for example a multiple of a periodic pattern such as the HARQ, which is 8 subframes. Use of subframe configuration patterns in connection with HARQ will be further described below.

According to some aspects, the subframe configuration pattern is selected from a number of predefined configurations.

Then the first radio network node switches S4 between transmission and reception in accordance with the shared subframe configuration pattern, when exchanging data between the first radio network node and the second radio network node. Data is here used as referring to any data of any operation i.e. either control plane data or user plane data. The processing circuitry 12 is configured to perform this step. According to some aspects, the processing circuitry comprises a switcher 124 adapted to perform this step.

In cellular systems like LTE, the radio network is scheduling the radio resources both in the uplink and in the downlink. In LTE the scheduling functionality is controlled in the eNodeB.

In the first embodiment wherein the radio network node is an access point 20, in LTE an eNodeB, the switching S4 implies that the scheduler in the access point e.g. the eNodeB, follows the subframe configuration pattern to schedule UL and DL data transmissions for the given UE. By defining a UE-specific subframe pattern the periodic DL channel/signal is guaranteed to be receivable by the given UE when they coincide with the configured DL subframe, and the periodic UL channel/signal are guaranteed to be transmitted by the given UE when they coincide with the configured UL subframe. It is noted that while for a given UE, the UE-specific subframe pattern defines subframes dedicated to DL reception only, to UL transmission only, or to guard subframe only, the eNB is not restricted to follow such pattern considering that the eNB serves multiple UEs in the cell simultaneously. In other words, for a given subframe, the eNB can have DL transmission to a first UE, UL reception from a second UE, and guard subframe with a third UE, such that the eNB operates in full-duplex mode without any resource wasted.

Hence, according to some aspects, wherein the first network node is an access point 20, then the switching S4 implies that the scheduler in the access point 20 schedules uplink and downlink transmissions between the first and second network nodes in accordance with the subframe configuration pattern.

A corresponding method is also performed in a linked wireless device 30, in LTE referred to as a User Equipment, UE. The method in a wireless device 30 is referred to as a second embodiment. It must be anticipated that the methods in an access point 20 and in a wireless device 30 are typically performed in parallel in two linked nodes.

In the second embodiment wherein the radio network node is a wireless device 30, in LTE a UE, the proposed method implies that the wireless device 20 has information about when it may be scheduled for transmissions (UL) or reception (DL) by the access point 20. Then the switching S4 implies that the wireless device is only required to receive or transmit in accordance with the subframe configuration pattern.

In other words, when a DL channel/signal falls outside of the designated DL subframes (i.e., fall under subframes for uplink or guard), then that DL channel/signal is skipped by the UE (i.e., UE cannot be expected to receive them). When a UL channel/signal falls outside of the designated UL subframes (i.e., fall under subframes for downlink or guard), then those UL channel/signals are dropped by the UE (i.e., UE cannot be expected to transmit them).

Hence, according to some aspects, wherein the first network node is a wireless device 30, then the switching S4 implies that the wireless device 30 is only required to transmit or receive in accordance with the subframe configuration pattern. If the subframe configuration pattern is selected in the first radio network node, this may be done in several different ways. According to some aspects, the method further comprises obtaining S1a a timing advance between the first and the second radio network node, obtaining S1b a radio access capability of one of the radio network nodes being a wireless device; and selecting S1c the subframe configuration pattern based on the obtained timing advance and radio access capability. The term radio access capability is a term used for the connection properties of the wireless device. The properties can be both hardware properties and what kind of connections the wireless device supports. Thus, the term describes how fast a wireless device can switch from DL-to-UL and UL-to-DL and is one component of the term that represents “UE capability”, “radio capability”, “UE radio access capability”. The processing circuitry 12 is configured to perform this step. According to some aspects, the processing circuitry comprises a selector 121 adapted to perform these steps.

According to some aspects the disclosure further relates to the above mentioned computer program, comprising computer readable code which, when run on a first radio network node, causes the node to perform any of the aspects of the method described above and below.

Alternatively the subframe configuration pattern is selected based on network demands, user priority etc.

According to some aspects, method, further comprises calculating, S3, a UE-specific parameter of the subframe configuration pattern. The processing circuitry 12 is configured to perform this step. According to some aspects, the processing circuitry comprises a calculator 123 adapted to perform this step.

According to some aspects, the UE-specific parameter is a starting point of the subframe configuration pattern. Starting point of the configuration pattern can be derived from the UE ID. This is further exemplified under the heading “Configuration of Subframe Configuration Pattern” below.

Further details of the proposed technique will now be described. It will also be discussed how the Subframe Configuration Pattern may be defined, selected and implemented in different scenarios.

Low-Cost UE in HD-FDD Mode

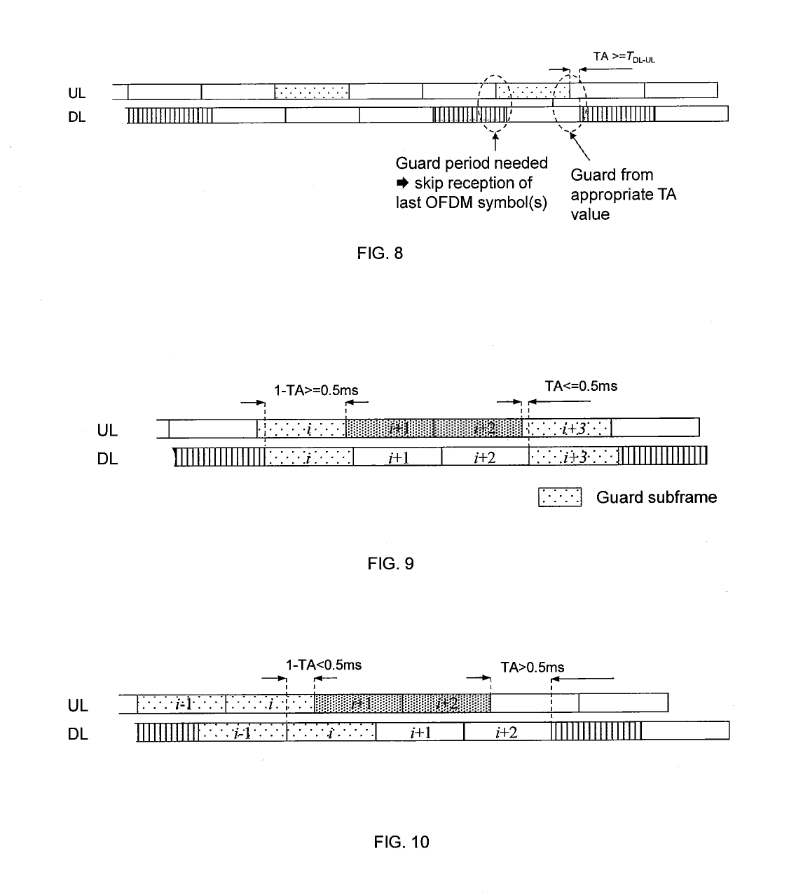

Current i.e. LTE Release 8, definition assumes small switching time 1 μs to 50 μs (<1 OFDM symbol; for example for cells between 100 m and 7.5 km), and small but not-close-to-zero Timing Advance, TA, (TA>=20 μs). Switching time for the downlink-to-uplink transition is created by allowing the UE to DRX the last OFDM symbols in a downlink subframe immediately preceding an uplink subframe. Switching time for the uplink-to-downlink transition is handled by setting the appropriate amount of timing advance in the UE. This is illustrated in FIG. 8. The same adjustment of the uplink timing from the eNB perspective is also applied to full duplex UEs.

As stated above, it can however be assumed that:
(a) For low complexity HD-FDD MTC UE, the Rx-to-Tx switching time is up to 1 ms if single oscillator is used
(b) For low complexity HD-FDD MTC UE, the Tx-to-Rx switching time is up to 1 ms if single oscillator is used

While most cells have a range less than 75 km (thus TA less than 500 μs), an LTE cell can have a range up to 100 km and require a TA up to 667 μs.

For FDD frame structure, transmission of the uplink radio frame number i from the UE shall start (N_{TA}+N_{TA offset})×Tₛ seconds before the start of the corresponding downlink radio frame at the UE, where 0≦N_{TA}≦20512, N_{TA offset}=0 for frame structure type 1 (FDD). Here NTA=20512 corresponds to the RTT of 20512/(15000×2048) (seconds)=667 μs.

The diagram in FIG. 9 illustrates the UL and DL subframe timing from the perspective of the low-cost UE. In the analysis below it is assumed that the low-cost UE needs 0.5 ms for ON-to-OFF switching time, and also 0.5 ms for OFF-to-ON switching time, due to the low-cost implementation choice at the UE.

When TA≦0.5 ms, the TA is not sufficient for the ON-to-OFF switching time, thus there is a need to put 1 ms of guard period to switch from UL to DL (FIG. 9).

FIG. 9 illustrates the guard periods of low-cost UE when TA>3.5 ms.

When 0.667 ms>TA>0.5 ms, the TA is sufficient for the ON-to-OFF switching time. But (1-TA) is not sufficient for OFF-to-ON switching time, thus there is a need to put 2 ms of guard period to switch from DL to UL (FIG. 10).

FIG. 10 illustrates the guard periods of low-cost UE when TA>0.5 ms.

As considered in 3GPP LTE Rel-8, the guard period can be a non-integer number of a subframe in general, which then cause DTX in a fraction of UL subframe, and/or DRX in a fraction of a DL subframe. For low-cost MTC UE, severe issues need to be considered in this case, as the guard period of low-cost MTC UE can be a substantial fraction of a subframe, rendering an entire DL (or UL) subframe useless as will be further explained below. The HARQ process will hereafter be used as one example of a periodic process, which may be affected when using half-duplex FDD. However, the principle of pre-defined subframe configuration patterns is of course also applicable in other situations as well.

Without losing generality, in the following, only guard period of an integer number of subframes is considered. However it should be understood that it is possible that a fraction of a subframe can be designated as guard, while the whole subframe can be designated as ‘DL special’ if the non-guard part of the subframe is used towards DL, and the whole subframe can be designated as ‘UL special’ if the non-guard part of the subframe is used towards UL, When this type of guard period is included, this simply requiring modifying the subframe configuration pattern to include such ‘DL special’ and/or ‘UL special’ subframes.

Number of HARQ Processes

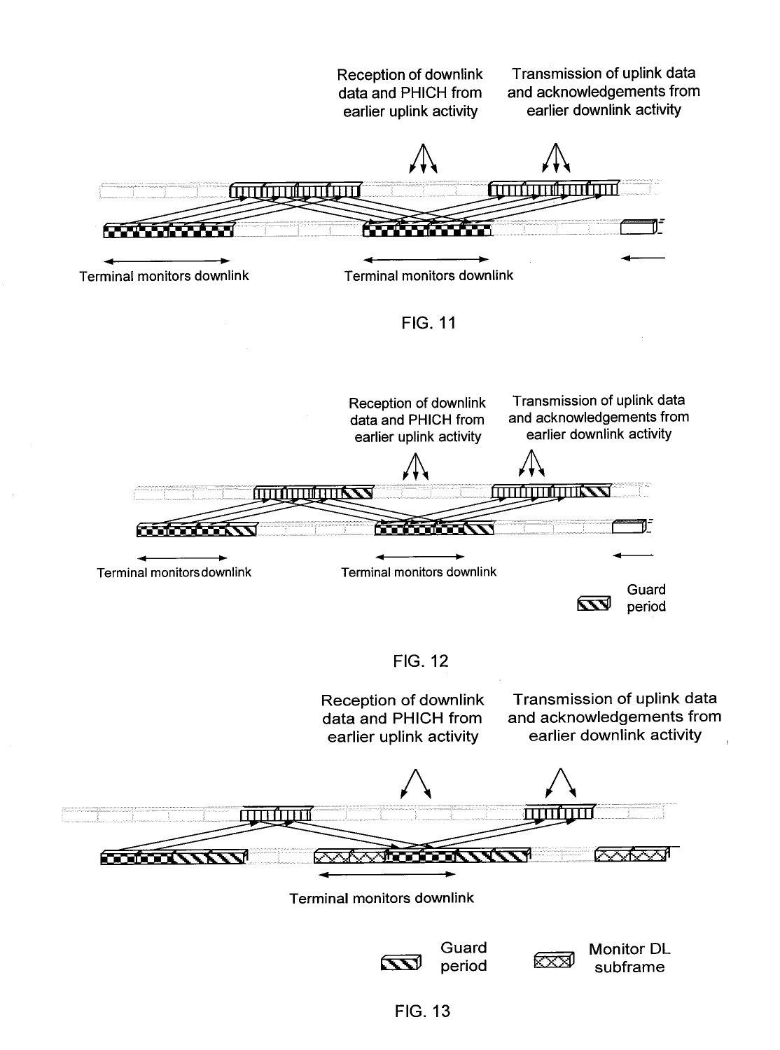

Assuming a normal UE (i.e., not low-cost) with sufficiently fast radio switching time, and assuming sufficient TA, the DL-to-UL and UL-to-DL timing is illustrated in FIG. 8. In this case, a maximum of 4 HARQ processes are possible, as illustrated in FIG. 11.

For low-cost UE with TA≦0.5 ms, there can be at most 3 parallel HARQ processes per UE, because there needs to be one subframe guard period to allow switching between UL and DL, as illustrated in FIG. 12.

For low-cost UE with TA>0.5 ms, there can be at most 2 parallel HARQ processes per UE, as illustrated in FIG. 13. Note that as illustrated in FIG. 13, there can be at most two parallel HARQ processes for UL and DL, because there needs to be two subframes guard period to allow switching between UL and DL. In addition, the UE can monitor at least 4 DL subframes out of every 8 subframes. During the Monitor DL subframes (‘Dm’):
the UE can receive channels and signals that do not require UL feedback. This includes broadcast type of information such as MIB, SIB, paging channel, RAR, PSS/SSS and
the UE can also perform measurements with reference signals including CRS and CSI-RS.

HARQ Timing without Subframe Configuration Pattern

As in LTE Rel-8 design, the HD-FDD UE can switch to UL only when necessary. In LTE Rel-8 if there is no UL transmission scheduled, the UE is required to detect DL. In accordance with this disclosure, there is subframe configuration pattern that the UE and eNB follow. Hence, the UE is only required to detect DL in specific frames.

HARQ Timing for Low-Cost UE and TA<=0.5 ms

In Table 1 below, all possible U/D/G (uplink, downlink, guard) subframe timing for 1-3 HARQ processes are illustrated for low-cost UE with TA<0.5 ms. Since the HARQ processes takes 8 subframes to make a round trip, while the radio frame contains 10 subframes, 4 radio frame (i.e., 40 subframes) contain one cycle of HARQ timing. If a HARQ process continues with more than 5 DL (and UL) transmissions, then the cycle repeats. All possible HARQ timing is included in the sense that other HARQ timing are simply time-shifted pattern of those in Table 1. For example, the first pattern of ‘1 HARQ process’ contains UL subframe in subframe indices [2, 0, 8, 6, 4]. There can be another pattern with subframes indices [0, 8, 6, 4, 2] or [8, 6, 4, 2, 0] etc., but they are not included since they are simply a time-shifted version of [2, 0, 8, 6, 4]. Similarly, the first pattern of ‘2 HARQ process’ contains UL subframe in subframe indices [(1,2), (9,0),(7,8),(5, 6), (3,4)]. It's time-shifted pattern, e.g., [(9,0),(7,8),(5, 6), (3,4),(1,2)] is considered equivalent and thus not included.

In Table 1, subframe #0 and #5 are highlighted in italics to show that the UE are expected to receive DL transmission in subframe #0 and #5, which carries PBCH, SIB1, and PSS/SSS. The conflict with PBCH/SIB1/PSS/SSS reception is highlighted by a hyphen e.g. G′, U′, where the HARQ timing requires them to be either guard subframe or; DL subframe. The subframes that are left in blank are subframes (e.g., the ‘Dm’ subframes in FIG. 13) during which the UE can receive DL transmission for monitoring purpose, but the eNB cannot send PDSCH transmission that requires UL response.

In Table 2, the UL subframes and Guard subframes shaded out due to conflict with subframe #0 and #5; Some UL subframes are turned into Guard periods (underlined G) due to the conflict.

Taking out the shaded out subframes of Table 2, i.e., making them DL monitoring subframes Dm, we get Table 3. Table 3 provides all possible U/D/G patterns for the possible HARQ processes the eNB and UE and use. This includes DL HARQ process as well as UL HARQ process.

TABLE 1
All possible U/D/G subframe timing for 1-3 HARQ processes, assuming low-cost UE
with TA <0.5 ms, when not fixing subframe #0 and #5 to be DL.

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | G | U1 | G | | | D1 | | | G | U′ | G | | | D1 | | | G | U1 | G |
| 1 HARQ Process | | D1 | | | G | U′ | G | | | D1 | | | G | U1 | G | | | D1 | | |
| 2 HARQ Process | G′ | U1 | U2 | G | | D1 | D2 | | G | U1 | U′ | G | | D1 | D2 | | G | U1 | U2 | G |
| 2 HARQ Process | | G | U1 | U2 | G | | D1 | D2 | | G | U′ | U2 | G | | D1 | D2 | | G | U1 | U2 |
| 3 HARQ Process | G′ | U1 | U2 | U3 | G | D1 | D2 | D3 | G | U1 | U′ | U3 | G | D1 | D2 | D3 | G | U1 | U2 | U3 |
| 3 HARQ Process | D3 | G | U1 | U2 | U3 | G′ | D1 | D2 | D3 | G | U′ | U2 | U3 | G | D1 | D2 | D3 | G | U1 | U2 |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | | G′ | U1 | G | | | D1 | | | G | U1 | G′ | | | D1 | |
| 1 HARQ Process | G′ | U1 | G | | | D1 | | | G | U1 | G′ | | | D1 | | | G | U1 | G | |
| 2 HARQ Process | | D1 | D2 | | G | U′ | U2 | G | | D1 | D2 | | G | U1 | U2 | G′ | | D1 | D2 | |
| 2 HARQ Process | G′ | | D1 | D2 | | G′ | U1 | U2 | G | | D1 | D2 | | G | U1 | U′ | G | | D1 | D2 |
| 3 HARQ Process | G′ | D1 | D2 | D3 | G | U′ | U2 | U3 | G | D1 | D2 | D3 | G | U1 | U2 | U′ | G | D1 | D2 | D3 |
| 3 HARQ Process | U′ | G | D1 | D2 | D3 | G′ | U1 | U2 | U3 | G | D1 | D2 | D3 | G | U1 | U′ | U3 | G | D1 | D2 |

TABLE 2
All possible U/D/G subframe timing for 1-3 HARQ processes, with disallowed U/G subframes shaded.

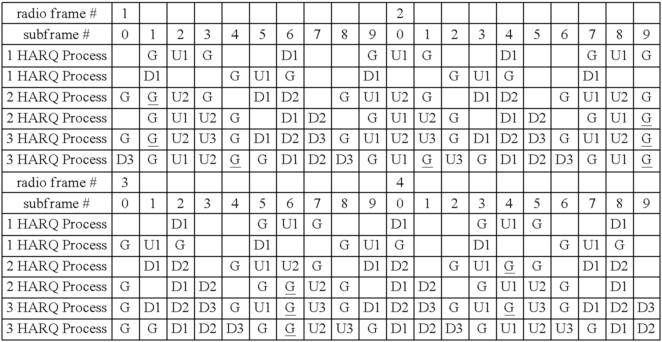

TABLE 3
All usable U/D/G subframe timing for 1-3 HARQ processes, assuming low-cost UE
with TA <0.5 ms.

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | G | U1 | G | | | D1 | | | | | | | | D1 | | | G | U1 | G |
| 1 HARQ Process | | D1 | | | | | | | | D1 | | | G | U1 | G | | | D1 | | |
| 2 HARQ Process | | G | U2 | G | | D1 | D2 | | | | | | | D1 | D2 | | G | U1 | U2 | G |
| 2 HARQ Process | | G | U1 | U2 | G | | D1 | D2 | | | | | | | D1 | D2 | | G | U1 | G |
| 3 HARQ Process | | G | U2 | U3 | G | D1 | D2 | D3 | | | | | | D1 | D2 | D3 | G | U1 | U2 | G |
| 3 HARQ Process | D3 | G | U1 | U2 | G | | D1 | D2 | D3 | | | G | U3 | G | D1 | D2 | D3 | G | U1 | G |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | | | | | | | D1 | | | | | | | | D1 | |
| 1 HARQ Process | | | | | | D1 | | | | | | | | D1 | | | G | U1 | G | |
| 2 HARQ Process | | D1 | D2 | | | | | | | D1 | D2 | | G | U1 | G | | | D1 | D2 | |
| 2 HARQ Process | | | D1 | D2 | | | G | U2 | G | | D1 | D2 | | | | | | | D1 | |
| 3 HARQ Process | | D1 | D2 | D3 | | | G | U3 | G | D1 | D2 | D3 | G | U1 | G | | | D1 | D2 | D3 |
| 3 HARQ Process | | | D1 | D2 | D3 | | G | U2 | U3 | G | D1 | D2 | D3 | | | | | | D1 | D2 |

For example, if the TA<0.5 ms and the subframe #0 and #5 are reserved to be DL, then for three HARQ processes there are two possible patterns, as shown in table 3 above (the two lowest rows). These patterns have a common downlink subframe pattern, where in terms of DL subframes there is only a relative shift of 1 subframe between the two lowest rows.

For example, for the last row in Table 3 (3 HARQ Process), downlink subframes are scheduled at the 0th, 1st, 2nd, 8th, 9th, 10th, 16th, 17th, 18th, 24th, 25th, 26th, 32nd, 33rd, 34th subframe every 40^{th} subframe, when the 0^{th} subframe in the 40 ms periodic pattern is taken as the 0-th subframe in the 4-th radio frame shown in Table 3 above. Note that due to the periodic nature of the 40 ms pattern, the labeling of the DL subframes can start anywhere in the 40 ms pattern.

Other ways to label the DL subframes in the 40 ms pattern is illustrated in tables 3b and 3c below. In Table 3b the DL pattern starts at subframe sub frame #5 assuming the first “3 HARQ Process” and in Table 3c the DL pattern starts at subframe sub frame #6 assuming the second “3 HARQ Process”.

TABLE 3b
Example DL subframe pattern with 3 HARQ processes TA <0.5 ms and fixing
subframe #0 and #5 to be DL.
Downlink transmission pattern

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 3 HARQ Process | | G | U2 | U3 | G | D1 | D2 | D3 | | | | | | D1 | D2 | D3 | G | U1 | U2 | G |
| DL TX | 35 | 36 | 37 | 38 | 39 | 0 | 1 | 2 | 3 | 4 | 5 | 6 | 7 | 8 | 9 | 10 | 11 | 12 | 13 | 14 |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 3 HARQ Process | | D1 | D2 | D3 | | | G | U3 | G | D1 | D2 | D3 | G | U1 | G | | | D1 | D2 | D3 |
| DL TX | 15 | 16 | 17 | 18 | 19 | 20 | 21 | 22 | 23 | 24 | 25 | 26 | 27 | 28 | 29 | 30 | 31 | 32 | 33 | 34 |

Table 3b illustrates that for a subframe pattern comprising 3 HARQ processes and for a 40 ms sub frame pattern starting at frame 5 in the radio frame 1, downlink subframes are scheduled at the 0th, 1st, 2nd, 8th, 9th, 10th, 16th, 17th, 18th, 24th, 25th, 26th, 32nd, 33rd, 34th subframe.

TABLE 3c
Example DL subframe pattern with 3 HARQ processes TA <0.5 ms and fixing
subframe #0 and #5 to be DL.
Downlink transmission pattern

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 3 HARQ Process | D3 | G | U1 | U2 | G | | D1 | D2 | D3 | | | G | U3 | G | D1 | D2 | D3 | G | U1 | G |
| DL TX | 34 | 35 | 36 | 37 | 38 | 39 | 0 | 1 | 2 | 3 | 4 | 5 | 6 | 7 | 8 | 9 | 10 | 11 | 12 | 13 |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 3 HARQ Process | | | D1 | D2 | D3 | | G | U2 | U3 | G | D1 | D2 | D3 | | | | | | D1 | D2 |
| DL TX | 14 | 15 | 16 | 17 | 18 | 19 | 20 | 21 | 22 | 23 | 24 | 25 | 26 | 27 | 28 | 29 | 30 | 31 | 32 | 33 |

Table 3c illustrates that for a subframe pattern comprising 3 HARQ processes and for a 40 ms sub frame pattern starting at frame 6 in the radio frame 1, DL subframes are also scheduled at the 0th, 1st, 2nd, 8th, 9th, 10th, 16th, 17th, 18th, 24th, 25th, 26th, 32nd, 33rd, 34th subframe.

Hence, this disclosure proposes that DL transmissions from eNB are scheduled in these subframes, provided that there is data or control signalling to be scheduled. This implies that the UE is only required to be able to receive transmissions in these frames.

HARQ Timing for Low-Cost UE and TA>0.5 ms

Similarly, in Table 4 below, all possible U/D/G (uplink, downlink, guard) subframe timing for 1-2 HARQ processes are illustrated for low-cost UE with TA>0.5 ms. Similarly, 4 radio frame captures the full cycle of HARQ timing in terms of which subframes are used for DL, UL, or guard.

In Table 5, the UL subframes and Guard subframes shaded out due to conflict with subframe #0 and #5; Some UL subframes are turned into Guard periods (underlined ‘G’) due to the conflict.

Taking out the shaded out subframes of Table 5, i.e., making them DL monitoring subframes Dm, we get Table 4. Table 6 provides all possible U/D/G patterns for the possible HARQ processes the eNB and UE and use. This includes DL HARQ process as well as UL HARQ process.

TABLE 4
Possible U/D/G subframe timing for 1-2 HARQ processes, assuming low-cost UE with
TA >0.5 ms, when not fixing subframe #0 and #5 to be DL.

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | G′ | G | U1 | | | | D1 | | G | G | U1′ | | | | D1 | | G | G | U1 | |
| 1 HARQ Process | | G | G | U1 | | | | D1 | | G | G′ | U1 | | | | D1 | | G | G | U1 |
| 2 HARQ Process | G′ | G | U1 | U2 | | | D1 | D2 | G | G | U1 | U2 | | | D1 | D2 | G | G | U1 | U2 |
| 2 HARQ Process | D2 | G | G | U1 | U2 | | | D1 | D2 | G | G′ | U1 | U2 | | | D1 | D2 | G | G | U1 |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | G | G′ | U1 | | | | D1 | | G | G | U1 | | | | D1 | |
| 1 HARQ Process | | | | D1 | | G′ | G | U1 | | | | D1 | | G | G | U1′ | | | | D1 |
| 2 HARQ Process | | | D1 | D2 | G | G′ | U1 | U2 | | | D1 | D2 | G | G | U1 | U2′ | | | D1 | D2 |
| 2 HARQ Process | U2′ | | | D1 | D2 | G′ | G | U1 | U2 | | | D1 | D2 | G | G | U1 | U2 | | | D1 |

TABLE 5
All possible U/D/G subframe timing for 1-2 HARQ processes, with disallowed U/G subframes shaded.

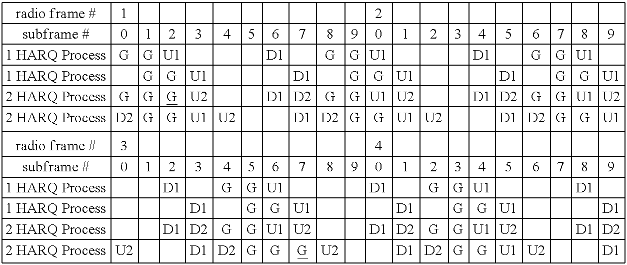

TABLE 6
All usable U/D/G subframe timing for 1-2 HARQ processes, assuming low-cost UE
with TA <0.5 ms.

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | | | | | D1 | | | | | | | | D1 | | G | G | U1 | |
| 1 HARQ Process | | G | G | U1 | | | | D1 | | | | | | | | D1 | | G | G | U1 |
| 2 HARQ Process | | G | G | U2 | | | D1 | D2 | | | | | | | D1 | D2 | G | G | U1 | U2 |
| 2 HARQ Process | D2 | G | G | U1 | U2 | | | D1 | D2 | | | | | | | D1 | D2 | G | G | U1 |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | | | | | | | D1 | | G | G | U1 | | | | D1 | |
| 1 HARQ Process | | | | D1 | | | | | | | | D1 | | | | | | | | D1 |
| 2 HARQ Process | | | D1 | D2 | | | | | | | D1 | D2 | G | G | U1 | | | | D1 | D2 |
| 2 HARQ Process | | | | D1 | D2 | | G | G | U2 | | | D1 | D2 | | | | | | | D1 |

HARQ Timing with Subframe Configuration Pattern

This disclosure proposes that as an alternative to the Rel-8 design, for HD-FDD, one or more subframe configuration patterns can be adopted. In this case, the UE follows the predefined pattern to switch DL-to-UL, and UL-to-DL. The scheduler in eNB also follows the subframe configuration pattern to schedule UL and DL data transmission and/or control information. The UE is only required to listen to the uplink in the dedicated DL frames of the subframe configuration pattern.

When using a predefined subframe configuration pattern, the timing of DL, UL, and Guard subframes are fixed and known to eNB and UE.

For low-cost UE and TA<=0.5 ms, the subframe configuration pattern can follow either of the “3 HARQ Process” pattern in Table 3.

According to some aspects, the UE does not only switch to UL when signaled by the eNB, but may switch to UL in accordance with the pattern even when not scheduled.

In Table 7, the U/D/G subframe timing is shown when using the subframe configuration pattern of the first “3 HARQ Process” pattern in Table 3. The three “1 HARQ Process” pattern illustrates the timing of (U1, D1), (U2, D2), (U3, D3), respectively. The three “2 HARQ Process” pattern illustrates the timing of [(U1, D1), (U2, D2)], [U1,D1),(U3,D3)],[(U2,D2),(U3,D3)], respectively. The “3 HARQ Process” pattern illustrates the timing of [(U1, D1), (U2, D2), (U3, D3)]. In Table 7, the UL subframes that are not used for any HARQ process is denoted as ‘v’. These ‘v’ subframes can be used for transmission of UL channel/signal that are not involved in a HARQ process, for example, PUCCH carrying CSI, PRACH, scheduling request (SR).

Similarly, in Table 8, the U/D/G subframe timing is shown when using the subframe configuration pattern of the second “3 HARQ Process” pattern in Table 3.

TABLE 7
U/D/G subframe timing when using the subframe configuration pattern of the first “3 HARQ
Process” pattern in Table 3.

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | G | v | v | G | D1 | | | | | | | | D1 | | | G | U1 | v | G |
| 1 HARQ Process | | G | U2 | v | G | | D2 | | | | | | | | D2 | | G | v | U2 | G |
| 1 HARQ Process | | G | v | U3 | G | | | D3 | | | | | | | | D3 | G | v | v | G |
| 2 HARQ Process | | G | U2 | v | G | D1 | D2 | | | | | | | D1 | D2 | | G | U1 | U2 | G |
| 2 HARQ Process | | G | v | U3 | G | D1 | | D3 | | | | | | D1 | | D3 | G | U1 | v | G |
| 2 HARQ Process | | G | U2 | U3 | G | | D2 | D3 | | | | | | | D2 | D3 | G | v | U2 | G |
| 3 HARQ Process | | G | U2 | U3 | G | D1 | D2 | D3 | | | | | | D1 | D2 | D3 | G | U1 | U2 | G |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | | | | G | v | G | D1 | | | G | U1 | G | | | D1 | |
| 1 HARQ Process | | | D2 | | | | G | v | G | | D2 | | G | v | G | | | | D2 | |
| 1 HARQ Process | | | | D3 | | | G | U3 | G | | | D3 | G | v | G | | | | | D3 |
| 2 HARQ Process | | D1 | D2 | | | | G | v | G | D1 | D2 | | G | U1 | G | | | D1 | D2 | |
| 2 HARQ Process | | D1 | | D3 | | | G | U3 | G | D1 | | D3 | G | U1 | G | | | D1 | | D3 |
| 2 HARQ Process | | | D2 | D3 | | | G | | U3 | G | | D2 | D3 | G | v | G | | | D2 | D3 |
| 3 HARQ Process | | D1 | D2 | D3 | | | G | U3 | G | D1 | D2 | D3 | G | U1 | G | | | D1 | D2 | D3 |

TABLE 8
U/D/G subframe timing when using the subframe configuration pattern of the second “3
HARQ Process” pattern in Table 3.

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | G | U1 | v | G | | D1 | | | | | G | v | G | D1 | | | G | U1 | G |
| 1 HARQ Process | | G | v | U2 | G | | | D2 | | | | G | v | G | | D2 | | G | v | G |
| 1 HARQ Process | D3 | G | v | v | G | | | | D3 | | | G | U3 | G | | | D3 | G | v | G |
| 2 HARQ Process | | G | U1 | U2 | G | | D1 | D2 | | | | G | v | G | D1 | D2 | | G | U1 | G |
| 2 HARQ Process | D3 | G | U1 | v | G | | D1 | | D3 | | | G | U3 | G | D1 | | D3 | G | U1 | G |
| 2 HARQ Process | D3 | G | v | U2 | G | | | D2 | D3 | | | G | U3 | G | | D2 | D3 | G | v | G |
| 3 HARQ Process | D3 | G | U1 | U2 | G | | D1 | D2 | D3 | | | G | U3 | G | D1 | D2 | D3 | G | U1 | G |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | | | G | v | v | G | D1 | | | | | | | | D1 | |
| 1 HARQ Process | | | | D2 | | | G | U2 | v | G | | D2 | | | | | | | | D2 |
| 1 HARQ Process | | | | | D3 | | G | v | U3 | G | | | D3 | | | | | | | |
| 2 HARQ Process | | | D1 | D2 | | | G | U2 | v | G | D1 | D2 | | | | | | | D1 | D2 |
| 2 HARQ Process | | | D1 | | D3 | | G | v | U3 | G | D1 | | D3 | | | | | | D1 | |
| 2 HARQ Process | | | | D2 | D3 | | G | U2 | U3 | G | | D2 | D3 | | | | | | | D2 |
| 3 HARQ Process | | | D1 | D2 | D3 | | G | U2 | U3 | G | D1 | D2 | D3 | | | | | | D1 | D2 |

HARQ Timing for Low-Cost UE and TA>0.5 ms

Similar to the TA<=0.5 ms situation in Table 7 and Table 8, Table 9 and Table 10 provide the U/D/G subframe timing for TA>0.5 ms.

TABLE 9
U/D/G subframe timing when using the subframe configuration pattern of the first “2 HARQ
Process” pattern in Table 6

| radio frame # | 1 | | | | | | | | | | 2 | | | | | | | | | |
|---|---|---|---|---|---|---|---|---|---|---|---|---|---|---|---|---|---|---|---|---|
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | G | G | v | | | D1 | | | | | | | | D1 | | G | G | U1 | v |
| 1 HARQ Process | | G | G | U2 | | | | D2 | | | | | | | | D2 | G | G | v | U2 |
| 2 HARQ Process | | G | G | U2 | | | D1 | D2 | | | | | | | D1 | D2 | G | G | U1 | U2 |
| radio frame # | 3 | | | | | | | | | | 4 | | | | | | | | | |
| subframe # | 0 | 1 | 2 | 3 | 4 | 5 | 6 | 7 | 8 | 9 | 0 | 1 | 2 | 3 | 4 | 5 | 6 | 7 | 8 | 9 |
| 1 HARQ Process | | | D1 | | | | | | | | D1 | | G | G | U1 | | | | D1 | |
| 1 HARQ Process | | | | D2 | | | | | | | | D2 | G | G | v | | | | | D2 |
| 2 HARQ Process | | | D1 | D2 | | | | | | | D1 | D2 | G | G | U1 | | | | D1 | D2 |

TABLE 10
U/D/G subframe timing when using the subframe configuration pattern of the second “2
HARQ Process” pattern in Table 6

| radio frame # | 1 | | | | | | | 2 | | | | | | 3 | | | | | | 4 | | | |
|---|---|---|---|---|---|---|---|---|---|---|---|---|---|---|---|---|---|---|---|---|---|---|---|
| 1 HARQ Process | | G | G | U1 | v | D1 | | | D1 | | G | G | U1 | | D1 | | G | G | v | | D1 | | D1 |
| 1 HARQ Process | D2 | G | G | v | U2 | | D2 | | | D2 | G | G | v | | | D2 | G | G | U2 | | | D2 | |
| 2 HARQ Process | D2 | G | G | U1 | U2 | D1 | D2 | | D1 | D2 | G | G | U1 | | D1 | D2 | G | G | U2 | | D1 | D2 | D1 |

Configuration of Subframe Configuration Pattern

Certain parameters of the subframe timing pattern can be configured in a UE-specific manner, in order to enable multiplexing between UEs from the standpoint of eNB. In one embodiment, starting point of the configuration pattern can be derived from the UE ID. For example, the pattern starts with a radio frame which has:

(n_{f}−N_{HD}_{_}_{offset})mod N_{HD}_{_}_{period}=0

Where n_{f} is the radio frame index. NHD_offset is a UE-specific HD_FDD offset value. One example is to set:

N_{HD}_{_}_{offset}=n_{RNTI} mod N_{HD}_{_}_{period}

NHD_period is the periodicity of the HD-FDD configuration pattern, and n_{RNTI} is a UE ID. Using the patterns listed above, NHD_period=4 (radio frames).

UE-specific offset allows time-dimension multiplexing between UEs since UEs with different ID will likely get different pattern starting point.

Defining subframe configuration pattern allows the UE (and/or eNB) to signal which pattern it needs to operate with according to the UE capability (low-cost UE vs normal UE) and timing advance, so that the eNB and UE can mutually understand when DL and UL transmission is possible.

It is also possible to define a list of configuration patterns for other HARQ round trip time. For example, HARQ round trip time may be relaxed to 9 subframes for Rel-13, where UE takes 5 subframes to respond to a DL transmission on the uplink, while eNB still takes 4 subframes to respond to a UL transmission on the downlink. In this case, a different set of subframe configuration patterns can be defined.

The following observations have been made:
For all patterns in Table 3, Table 6, Table 7-Table 10, there are two UL subframes in the 40-subframe cycle associated with any given HARQ process.
For all patterns in Table 3, Table 6, Table 7-Table 10 the majority of subframes are required to be DL due to the need to receive subframe #0 and #5 in a radio frame.
For design without subframe configuration pattern:
   For patterns in Table 3, the number of Guard subframes in the 40-subframe cycle range from 4 to 8.
   For patterns in 6, the number of Guard subframes in the 40-subframe cycle range from 4 to 6.
For design with subframe configuration pattern:
   For patterns in Table 7 and Table 8, the number of Guard subframes in the 40-subframe cycle is 8.
   For patterns in Table 9 and Table 10, the number of Guard subframes in the 40-subframe cycle is 6.
For design with subframe configuration pattern, the UL transmission not associated with HARQ process is built in the pattern. For designs without subframe configuration pattern, the UL transmission not associated with HARQ process will puncture into the HARQ pattern.

### CONCLUDING REMARKS

On the downlink, normally there are several subframes that an FDD UE is required to receive.
(a) Paging. For UE in RRC_IDLE mode, the UE needs to be prepared to receive the paging channel in subframe #0, #4, #5, and #9. Paging is also used in RRC_CONNECTED to notify a coming modification of SIBs.
(b) PBCH/SIB1/PSS/SSS: For UE in RRC_CONNECTED mode, the UE needs to receive subframe #0 and #5 always, which carries broadcast type of information including PBCH, SIB1, PSS, and SSS. Due to the implementation, low-cost UE likely needs to receive multiple instances of PBCH/SIB1/PSS/SSS to properly receive it.
(c) PHICH. When the eNB is expected to transmit PHICH in response to an earlier PUSCH transmission, normally the UE needs to switch to DL to receive the PHICH. Compared to paging and broadcast information, dropping of PHICH is tolerable since this can be made up by retransmission opportunities. It is worth noting that for the purpose of receiving PHICH, it is feasible that the UE only receives the control region (up to 4 OFDM symbols) while skipping the data region of the same subframe.
(d) CSI-RS. The CSI-RS periodicity T_{CSI-RS} can be {5, 10, 20, 40, 80} subframes. The eNB can configure the CSI-RS such that the subframe for CSI-RS coincide with other required DL signal, for example, subframe #0 and #5. With this, CSI-RS does not impose additional constraint on the DL-UL subframe timing.
(e) SPS DL. After a Semi-Persistent downlink assignment is configured, the UE shall consider sequentially that the DL assignment occurs with interval of semiPersistSchedIntervalDL, where semiPersistSchedIntervalDL is configured by RRC signaling. semiPersistSchedIntervalDL can be {10, 20, 32, 40, 64, 80, 128, 160, 320, 640} subframes. Similar to CSI-RS, SPS DL can be configured such that it does not impose additional constraint on the DL-UL subframe timing.

For low-cost UE operating in HD-FDD mode, it is still necessary to receive the mandatory DL information listed above. Whenever possible, the UE needs to finish ON-to-OFF switching (when necessary), and be ready to receive the above-mentioned subframes on the downlink. If there is a conflict between DL reception and a lower-priority uplink transmission in these subframes, the DL signal can be protected by skipping the UL transmission.

On the uplink, while the initial transmission of a PUSCH is controllable by UL grants, there are several other types of channel/signal that a HD-FDD UE needs to transmit.
(a) PRACH. The UE needs to be able to perform random access by transmitting PRACH. The random access procedure can be triggered for a variety of reasons, such as UL data arrival and timing advance adjustment. PRACH should be assigned high priority since loss of PRACH opportunity may mean loss of physical connection.
(b) Scheduling Request (SR). SR may be carried by PUCCH with a periodicity SR_{PERIODICITY} of {1, 2, 5, 10, 20, 40, 80} ms. Due to the need to receive mandatory DL channels, it is impractical for a low-cost HD-FDD UE to accommodate the low end of the SR periodicity. It is desirable to maintain only the larger SR periodicity, for example, {5, 10, 20, 40, 80} ms.
(c) Periodic CSI Reporting using PUCCH. Periodicity N_{pd} for FDD can be {2, 5, 10, 20, 40, 80, 160, 32, 64, 128} ms. Similar to SR, it is impractical to have low periodicity of CSI reporting in HD-FDD mode. Considering the UL HARQ round trip time of 8 ms, it is desirable to maintain only the larger CSI periodicity of {40, 80, 160, 64, 128} ms.
(d) HARQ-ACK in response to DL transmission. There is a predefined {n, n+4} relationship between a PDSCH and its HARQ-ACK on the uplink. For HD-FDD under timing conflict, although it is undesirable, dropping of HARQ-ACK is not crippling since it can be simply treated as DTX which can already happen due to missed uplink grant or fading channel. The eNB will by default compensate by retransmission of the same transport block.
(e) PUSCH retransmission. For uplink data, the HARQ process synchronous, such that a retransmission follows 8 subframes after the initial transmission if the initial transmission failed. For HD-FDD under timing conflict, although undesirable, dropping of a PUSCH retransmission is acceptable since this can be treated the same as loss of PUSCH due to fading channel. The eNB will send a NACK on PHICH (or PDCCH), requesting a retransmission from the UE.
(f) Sounding reference signal (SRS). For Type 0 SRS configuration, the UE-specific SRS periodicity T_{SRS} for FDD can be {2, 5, 10, 20, 40, 80, 160, 320}. For Type 1 triggered SRS configuration, the UE Specific SRS periodicity T_{SRS,1} can be {2, 5, 10}.
(g) SPS UL. After a Semi-Persistent Scheduling uplink grant is configured, the UE shall consider sequentially that the UL grant occurs with interval of semiPersistSchedIntervalUL, where semiPersistSchedIntervalUL is configured by RRC signaling. semiPersistSchedIntervalUL can be {10, 20, 32, 40, 64, 80, 128, 160, 320, 640} subframes. Consider the HARQ round trip time of 8 subframes, it is preferred that the lower values of semiPersistSchedIntervalUL are not used in HD-FDD. That is, semiPersistSchedIntervalUL can be {32, 40, 64, 80, 128, 160, 320, 640} subframes for HD-FDD mode.

Considering the periodic channel/signals listed above, there exist conflicts between periodic downlink channel/signal, periodic uplink channel/signal, and the need for guard period when operating in HD-FDD mode. This conflict can be resolved by defining a UE-specific subframe pattern, similar to the TDD subframe configuration. In this case, the timing of Uplink-Downlink-Guard subframe is known to both eNB and UE.

The periodic DL channel/signal is guaranteed to be received when they coincide with the DL subframe, and the periodic UL channel/signal are guaranteed to be received when they coincide with the UL subframe. When the periodic DL channel/signal falls outside of the designated DL subframes (i.e., fall under subframes for uplink or guard), then those DL channel/signals are skipped by the UE (i.e., UE cannot be expected to receive them). When the periodic UL channel/signal falls outside of the designated UL subframes (i.e., fall under subframes for downlink or guard), then those UL channel/signals are dropped by the UE (i.e., UE cannot be expected to transmit them).

Within the context of this disclosure, the terms “wireless terminal” or “wireless device” encompass any device which is able to communicate wirelessly with another device, as well as, optionally, with an access node of a wireless network by transmitting and/or receiving wireless signals. Thus, the term “wireless device” encompasses, but is not limited to: a user equipment, e.g. an LTE UE, a mobile terminal, a stationary or mobile wireless device for machine-to-machine communication, an integrated or embedded wireless card, an externally plugged in wireless card, a dongle etc. Throughout this disclosure, the term “user equipment” is sometimes used to exemplify various embodiments. However, this should not be construed as limiting, as the concepts illustrated herein are equally applicable to other wireless devices. Hence, whenever a “user equipment” or “UE” is referred to in this disclosure, this should be understood as encompassing any wireless device as defined above.

1. A method, performed in a first radio network node in a cellular communication network, of communicating with a second radio network node using Half Duplex Frequency Division Duplex, HD-FDD, the method comprising:
sharing a pre-defined subframe configuration pattern with the second radio network node, and
switching between transmission and reception in accordance with the shared subframe configuration pattern, when exchanging data between the first radio network node and the second radio network node while using HD-FDD.

2. The method of claim 1, wherein the subframe configuration pattern specifies the subframes used for Uplink and Downlink during a period of time.

3. The method of claim 1, wherein the subframe configuration pattern further specifies subframe(s) that are wholly or partially used as guard period.

4. The method of claim 1 wherein the period of time comprises one or more periodic patterns.

5. The method of claim 1, wherein the periodicity is 40 subframes.

6. The method of claim 4, wherein the subframe configuration pattern implies that downlink transmission is scheduled at the 0th, 1st, 2nd, 8th, 9th, 10th, 16th, 17th, 18th, 24th, 25th, 26th, 32nd, 33rd, 34th subframes every 40th subframe.

7. The method of claim 1, wherein the subframe configuration pattern is selected from a number of predefined configurations.

8. The method of claim 1, further comprising:
obtaining a timing advance between the first and the second radio network node,
obtaining a radio access capability of one of the radio network nodes being a wireless device; and
selecting the subframe configuration pattern based on the obtained timing advance and radio access capability.

9. The method of claim 1, wherein the sharing comprises:
sending an indicator of the subframe configuration pattern to the second radio network node.

10. The method of claim 1, wherein the sharing comprises:
receiving an indicator of the subframe configuration pattern from the second radio network node.

11. The method of claim 1, further comprising:
calculating a wireless device-specific parameter of the subframe configuration pattern.

12. The method of claim 10, wherein the wireless device-specific parameter is a starting point of the subframe configuration pattern.

13. The method of claim 1, wherein the method further comprises the step of:
detecting an event triggering the sharing of a subframe configuration pattern.

14. The method of claim 1, wherein the first network node is an access point and wherein the switching indicates that the scheduler in the access point schedules uplink and downlink transmissions between the first and second network nodes in accordance with the subframe configuration pattern.

15. The method of claim 1, wherein the first network node is a wireless device and wherein the switching indicates that the wireless device is only required to transmit or receive in accordance with the subframe configuration pattern.

16. A first radio network node in a cellular communication network configured for cellular radio communication between the first radio network node and a second radio network node, the first radio network node, comprising:
a radio communication interface for communication with at least one second radio network node;
processing circuitry configured to cause the first radio network node:
to share a pre-defined subframe configuration pattern with the second radio network node, and
to switch between transmission and reception in accordance with the shared subframe configuration pattern, when exchanging data between the first radio network node and the second radio network node.

17. The first radio network node of claim 16, wherein the subframe configuration pattern specifies the subframes used for Uplink and Downlink during a period of time.

18. The first radio network node of claim 16, wherein the subframe configuration pattern specifies subframe(s) that are wholly or partially used as guard period.

19. The first radio network node of claim 16, wherein the period of time comprises one or more periodic patterns.

20. The first radio network node of claim 16, wherein the periodicity is 40 sub frames.

21. The first radio network node of claim 16, wherein subframe configuration pattern implies that downlink transmission is scheduled at the 0th, 1st, 2nd, 8th, 9th, 10th, 16th, 17th, 18th, 24th, 25th, 26th, 32nd, 33rd, 34th sub frames every 40th sub frame.

22. The first radio network node of claim 16, wherein the subframe configuration pattern is selected from a number of predefined configurations.

23. The first radio network node of claim 16, wherein the processing circuitry is further adapted to:
obtain a timing advance between the first and the second radio network node,
obtain a radio access capability of one of the radio network nodes being a wireless device; and
select the subframe configuration pattern based on the obtained timing advance and radio access capability.

24. The first radio network node of claim 16, wherein the processing circuitry is further adapted to:
send an indicator of the subframe configuration pattern to the second radio network node.

25. The first radio network node of claim 16, wherein the processing circuitry is further adapted to:
receive an indicator of the subframe configuration pattern from the second radio network node.

26. The first radio network node of claim 16, wherein the processing circuitry is further adapted to:
calculate a wireless device-specific parameter of the subframe configuration pattern.

27. The first radio network node of claim 16, wherein the wireless device-specific parameter is a starting point of the subframe configuration pattern.

28. The first radio network node of claim 16, wherein the processing circuitry is further adapted to:
detect an event triggering the sharing of a subframe configuration pattern.

29. The first radio network node of claim 16, wherein the first network node is an access point and wherein the processing circuitry is configured to schedule uplink and downlink transmissions between the first and second network nodes in accordance with the subframe configuration pattern.

30. The first radio network node of claim 16, wherein the first network node is a wireless device and wherein the processing circuitry is only required to transmit or receive in accordance with the subframe configuration pattern.

31. A computer program product comprising a non-transitory computer readable medium storing computer program code which, when executed in a radio network node, causes the radio network node to execute the method of claim 1.
